(19) United States
(12) Patent Application Publication
(10) Pub. No.: US 2026/0138582 A1
(43) Pub. Date: May 21, 2026

(54) SYSTEM AND METHOD FOR BURNISHING BRAKE PADS

(71) Applicant: GM Global Technology Operations LLC, Detroit, MI (US)

(72) Inventors: Jeehyung Lee, Seoul (KR); Sanghyun Song, Seoul (KR); Jian Jeong, Incheon (KR); Choonghee Rhew, Incheon (KR)

(73) Assignee: GM Global Technology Operations LLC, Detroit, MI (US)

(21) Appl. No.: 18/950,039

(22) Filed: Nov. 16, 2024

(51) Int. Cl. B60T 17/22; B60Q 9/00; F16D 66/02

(52) U.S. Cl. CPC B60T 17/22; B60Q 9/00; F16D 66/026

(57) ABSTRACT

A computer-implemented method that, when executed by data processing hardware, causes the data processing hardware to perform operations comprising determining a status of one or more brake pads of a vehicle, evaluating cumulative wear of the one or more brake pads, selecting a brake pressure calibration based on the cumulative wear, determining whether a wear limit has been met, and generating a notification indicating the one or more brake pads are fully burnished.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to vehicles and, more particularly, to a method of burnishing brakes.

Brake burnishing is a process used in the automotive industry, particularly for ensuring optimal performance and longevity of braking systems by creating a smooth and even surface on brake pads and rotors. Further, brake burnishing can significantly enhance the braking efficiency, reduce noise, and extend the lifespan of the brake system. When brake burnishing is not performed or brakes are not fully burnished, vehicle operators or owners often feel like the brakes are already being pushed when engaging a brake pedal.

While brake burnishing provides the foregoing advantages, traditional brake burnishing techniques can be time-consuming and may not always yield consistent results. Further, brake burnishing often takes longer in some electric vehicles due to the presence of regenerative brake systems. Shortcomings of existing vehicles and methods will be addressed by one or more aspects of the present disclosure.

### SUMMARY

In one configuration, a computer-implemented method that, when executed by data processing hardware, causes the data processing hardware to perform operations is provided. The operations include determining a status of one or more brake pads of a vehicle, evaluating cumulative wear of the one or more brake pads, selecting a brake pressure calibration based on the cumulative wear, determining whether a wear limit has been met, and generating a notification indicating the one or more brake pads are fully burnished.

The method may include one or more of the following optional aspects or steps. For example, determining the status of one or more brake pads of a vehicle further includes determining whether the one or more brake pads are new based on a mileage of the vehicle. Determining the status of the one or more brake pads of a vehicle further includes determining whether the one or more brake pads are new based on a replacement status.

According to one aspect, evaluating the cumulative wear of the one or more brake pads further includes collecting sensor data and using a model to estimate the cumulative wear.

According to another aspect, selecting the brake pressure calibration based on the cumulative wear can further include selecting a first brake pressure calibration. Determining whether the wear limit has been met can further include determining whether a first wear limit has been met. Selecting the brake pressure calibration based on the cumulative wear can further include selecting a second brake pressure calibration. Determining whether the wear limit has been met can further include determining whether a second wear limit has been met. Selecting the brake pressure calibration based on the cumulative wear can further include selecting a third brake pressure calibration. Determining whether the wear limit has been met can further include determining whether a third wear limit has been met.

In another configuration, a system is provided and includes data processing hardware and memory hardware in communication with the data processing hardware, the memory hardware storing instructions that, when executed on the data processing hardware, cause the data processing hardware to perform operations. The operations include determining a status of one or more brake pads of a vehicle, evaluating cumulative wear of the one or more brake pads, selecting a brake pressure calibration based on the cumulative wear, determining whether a wear limit has been met, and generating a notification indicating the one or more brake pads are fully burnished.

The system may include one or more of the following optional aspects or steps. For example, determining the status of one or more brake pads of the vehicle can further include determining whether the one or more brake pads are new based on one of a mileage of the vehicle and a replacement status.

According to at least one aspect, evaluating the cumulative wear of the one or more brake pads further includes collecting sensor data and using a model to estimate the cumulative wear.

According to another aspect, selecting the brake pressure calibration based on the cumulative wear can further include gradually decreasing additional brake pressure as cumulative wear increases.

According to at least one example, determining whether the wear limit has been met further includes determining whether the cumulative wear is greater than or equal to a burnished thickness of the brake pad.

A vehicle management system of a vehicle is provided and includes a vehicle brake system including one or more disc brakes having one or more brake pads, a sensor system including a vehicle status subsystem and a vehicle brake system sensor subsystem, data processing hardware, and memory hardware in communication with the data processing hardware, the memory hardware storing instructions that, when executed on the data processing hardware, cause the data processing hardware to perform operations. The operations include determining a status of the one or more brake pads, evaluating cumulative wear of the one or more brake pads, selecting a brake pressure calibration based on the cumulative wear, determining whether a wear limit has been met, and generating a notification indicating the one or more brake pads are fully burnished.

The vehicle management system may include one or more of the following optional aspects or steps. For example, determining the status of one or more brake pads of the vehicle further includes determining whether the one or more brake pads are new based on one of a mileage of the vehicle and a replacement status.

According to at least one aspect, evaluating the cumulative wear of the one or more brake pads can further include collecting sensor data and using a model to estimate the cumulative wear.

According to another aspect, selecting the brake pressure calibration based on the cumulative wear can further include gradually decreasing additional brake pressure as cumulative wear increases.

According to at least one example, determining whether the wear limit has been met can further include determining whether the cumulative wear is greater than or equal to a burnished thickness of the one or more brake pads.

### BRIEF DESCRIPTION OF THE DRAWINGS

The drawings described herein are for illustrative purposes only of selected configurations and are not intended to limit the scope of the present disclosure.

FIG. 1 is a schematic diagram of a vehicle environment including a vehicle management system according to principles of the present disclosure;

FIG. 2 is a schematic diagram of the vehicle management system of FIG. 1 including a vehicle brake system;

FIG. 3A is a side view of a brake pad of the vehicle brake system of FIG. 2;

FIG. 3B is a cross-sectional view of the brake pad of the vehicle brake system of FIG. 3A;

FIG. 4A is a graph depicting brake wear versus brake torque;

FIG. 4B is a graph depicting brake wear versus additional brake pressure; and

FIG. 5 is a flow diagram of a method of burnishing one or more brake pads of the vehicle brake system of FIG. 2 according to the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

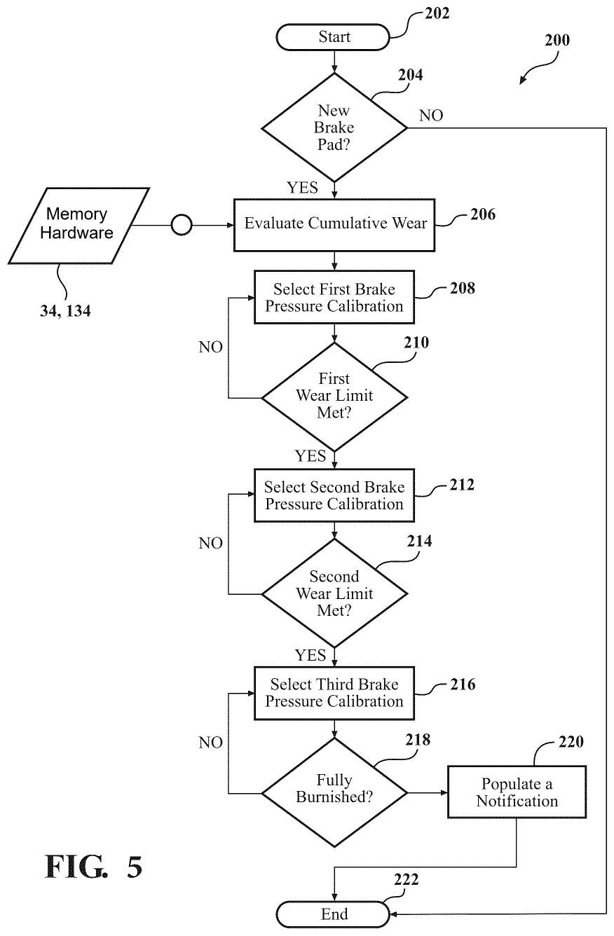

Referring to FIG. 1, an example vehicle operating environment 10 is provided for illustration of the principles of the present disclosure. The vehicle operating environment 10 includes a vehicle 100 and a vehicle service center 20. For the sake of illustration, the vehicle operating environment 10 is shown as including a single vehicle service center 20. However, in other examples, the vehicle operating environment 10 may include a plurality of vehicle service centers 20 in communication over a network 40 (e.g., the Internet, cellular networks).

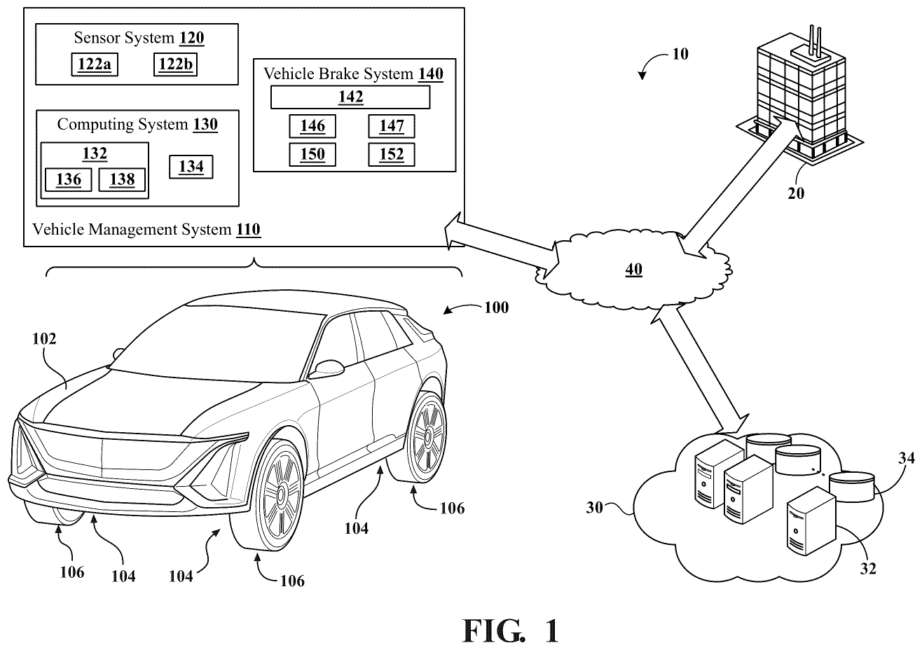

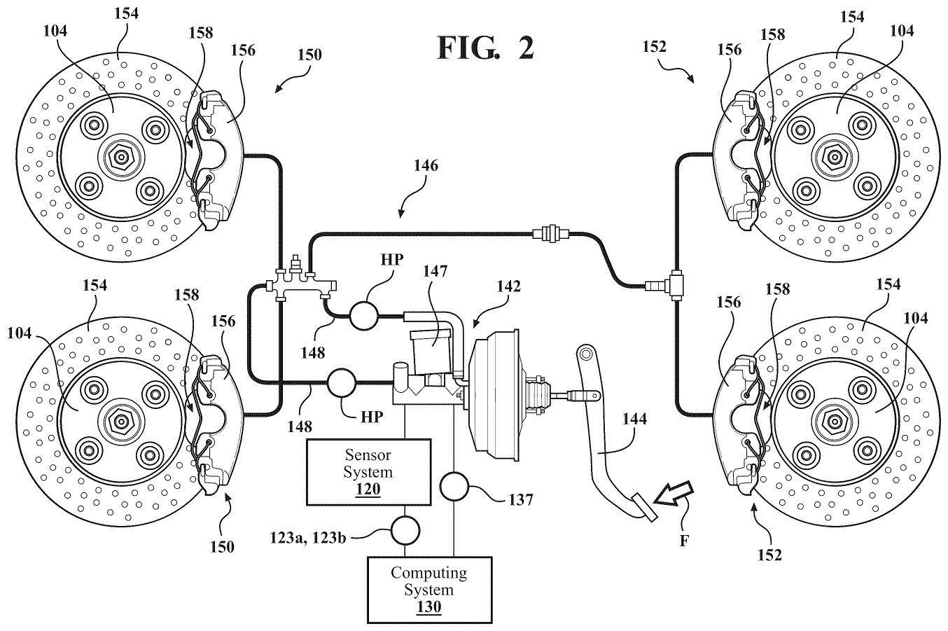

With reference to FIGS. 1 and 2, the vehicle 100 includes a vehicle body 102 that includes one or more wheel hubs 104 (FIG. 2) and one or more wheels 106 coupled to the one or more wheel hubs 104.

With reference to FIGS. 1 and 2, the vehicle 100 includes a vehicle management system 110 including a sensor system 120, a computing system 130, and a vehicle brake system 140. The vehicle management system 110 (FIG. 1) may be configured for gathering information (i.e., data) to evaluate and/or calculate brake wear and for dynamically adjusting brake pressure to achieve an intended brake torque.

The sensor system 120 includes various sensor subsystems 122a, 122b configured to gather sensor data 123a, 123b (FIG. 2). For instance, the sensor system 120 can include a vehicle status subsystem 122a that can include wheel speed sensors, accelerometers, odometers, or other sensors used in the automotive industry. The sensor system 120 can also include a vehicle brake system sensor subsystem 122b that includes one or more brake sensors that can be configured to gather information concerning the vehicle brake system 140 (e.g., brake pressure, brake pad thickness, brake pad temperature, rotor temperature, etc.).

As the sensor system 120 gathers the sensor data 123, the computing system 130 is configured to store, process, and/or communicate the sensor data 123 within the vehicle operating environment 10. In order to perform computing tasks related to the sensor data 123, the computing system 130 of the vehicle 100 includes data processing hardware 132 and memory hardware 134. The data processing hardware 132 is configured to execute instructions stored in the memory hardware 134 to perform computing tasks related to operation and management of the vehicle 100. Generally speaking, the computing system 130 refers to one or more locations of data processing hardware 132 and/or memory hardware 134.

The data processing hardware 132 may be embodied as a discrete microprocessor, an application specific integrated circuit (ASIC), or a dedicated control module, such as an electronic brake control module (EBCM) 136 that is coupled to the memory hardware 134. As will be discussed in more detail below, the EBCM 136 can be communicatively coupled to and configured to control and/or communicate instructions (e.g., brake pressure calibrations) 137 to a vehicle braking system 140. The vehicle 100 may also offer centralized vehicle control via a central processing unit (CPU) that is coupled to memory hardware 134 each of which may take on the form of a CD-ROM, magnetic disk, IC device, semiconductor memory (e.g., various types of RAM or ROM), etc., and a real-time clock (RTC). In at least one configuration, the CPU can be referred to as a vehicle control unit 138. The vehicle control unit 138 can be configured to receive, process, and/or communicate instructions with one or more systems of the vehicle 100 and/or one or more systems (e.g., a mobile device) remote from the vehicle 100 via the network 40.

In some examples, the computing system 130 is a local system located on the vehicle 100. When located on the vehicle 100, the computing system 130 may be centralized (i.e., in a single location/area on the vehicle 100), decentralized (i.e., located at various locations about the vehicle 100), or a hybrid combination of both (e.g., with a majority of centralized hardware and a minority of decentralized hardware). To illustrate some differences, a decentralized computing system 130 may allow processing to occur at an activity location while a centralized computing system 130 may allow for a central processing hub that communicates to systems located at various positions on the vehicle 100.

Additionally or alternatively, the computing system 130 includes computing resources that are located remotely from the vehicle 100. For instance, the computing system 130 may communicate via the network 40 with a remote vehicle computing system 30 (e.g., a remote computer/server or a cloud-based environment). Much like the computing system 130, the remote vehicle computing system 30 includes computing resources such as remote data processing hardware 32 and remote memory hardware 34. Here, sensor data 123 or other processed data (e.g., data processing locally by the computing system 130) may be stored in the remote vehicle computing system 30 and may be accessible to the computing system 130. In some examples, the computing system 130 is configured to utilize the remote resources 32, 34 as extensions of the computing resources 132, 134 such that resources of the computing system 130 may reside on resources of the remote vehicle computing system 30.

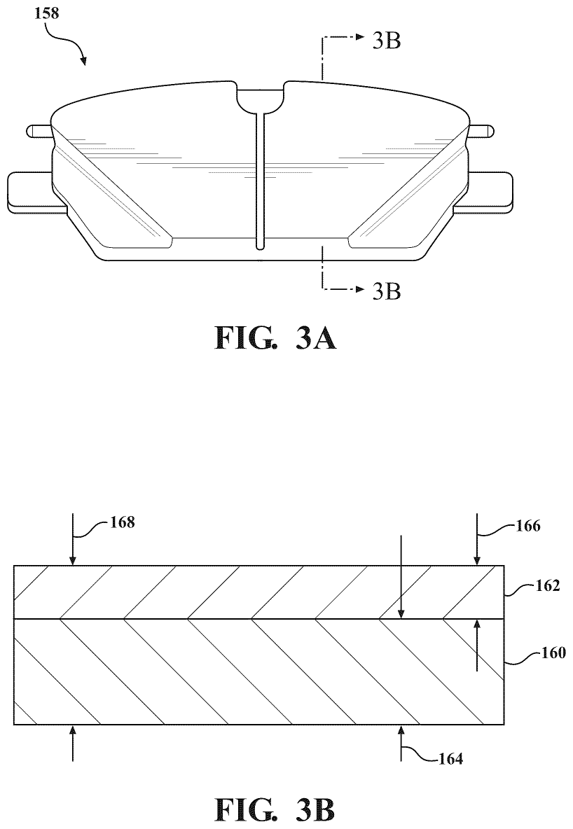

With reference to FIG. 2, an illustrative example of the vehicle management system 110 is provided. The vehicle brake system 140 can include a brake actuator, such as a master cylinder 142. A brake pedal 144 can be communicatively coupled with the master cylinder 142 and configured to be actuated by a user or operator of the vehicle 100. In general, when a force F is applied to the brake pedal 144, the master cylinder 142 converts the force F on the brake pedal 144 to hydraulic pressure HP by feeding brake fluid into a brake circuit 146. The vehicle brake system 140 can also include a booster 147 that is communicatively coupled to the master cylinder 142 and configured to selectively increase the hydraulic pressure HP within the brake circuit 146. The brake circuit 146 can include one or more conduits 148 that are communicatively coupled to at least one front disc brake 150 and/or at least one rear disc brake 152. The disc brakes 150, 152 each include a rotor (i.e., disc) 154 coupled to the wheel hub 104. A caliper or housing 156 is coupled to each rotor 154 and includes one or more brake pads 158 (FIG. 3A).

With reference to FIG. 3B, the brake pads 158 can include a main body 160 that has one or more layers of material and a lining 162 coupled to the main body 160. The main body 160 includes a first or main body thickness 164 and the lining 162 includes a second or lining thickness 166. The main body thickness 164 and the lining thickness 166 can collectively define a brake pad thickness 168. Note, in other configurations, additional layers not shown in the present illustrative configuration are possible. The brake pads 158 are new and considered unburnished when the lining thickness 166 is greater than a burnished thickness. As the brake pads 158 are used, the lining 162 begins to wear down due to a loss of material and are considered burnished when the lining thickness 166 is less than or equal to the burnished thickness. The loss of material can also be referred to as cumulative wear. Cumulative wear can be difficult to measure without removing the brake pads 158 from the vehicle 100 and manually measuring the brake pads 158 with a caliper or another measurement tool. One or more different models can be used to calculate and/or estimate the cumulative wear. For instance, a wear versus temperature (i.e., friction) model can be used to help calculate and/or estimate cumulative wear of the lining 162.

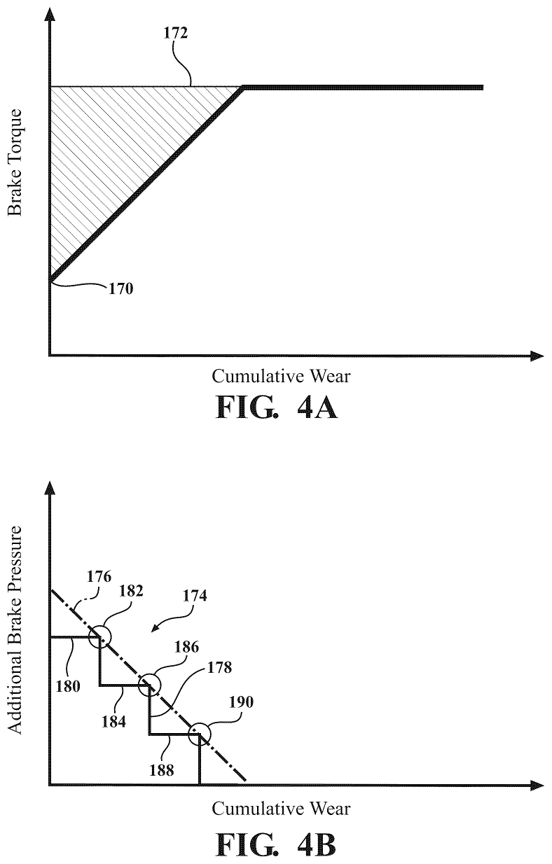

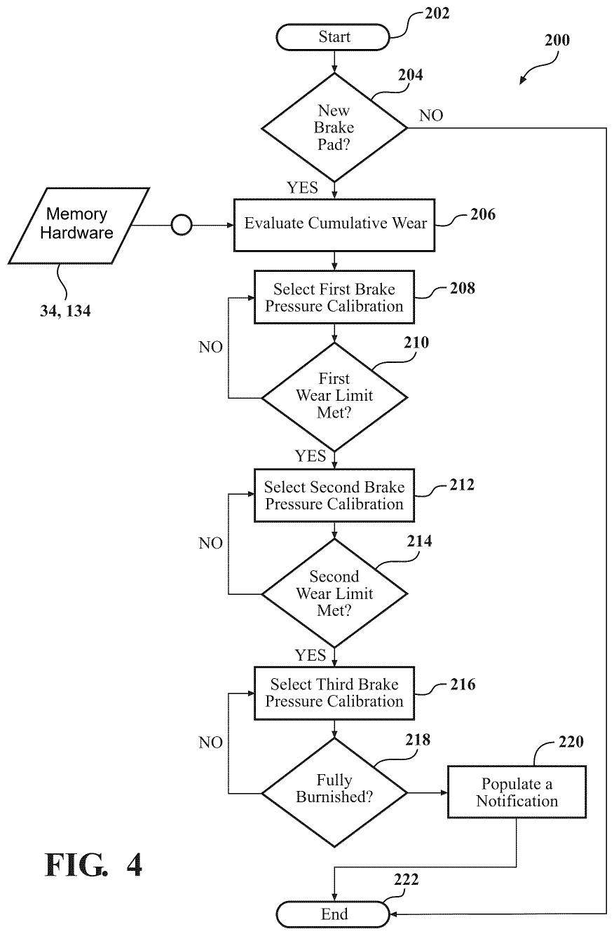

With reference to FIG. 4A, when the vehicle 100 is new or the brake pads 158 were recently replaced, the brake pads 158 can generally provide an initial actual brake torque 170 that is less than an intended brake torque 172. For purposes of the present disclosure, the intended brake torque 172 can refer an amount of brake torque that a user would deem desirable for comfortable deceleration of the vehicle 100.

With reference to FIG. 4B, as will be discussed in more detail below, additional brake pressure 174 can be applied via the booster 147 or otherwise based on the cumulative wear of the lining 162. In other words, the additional brake pressure 174 can be applied by the booster 147 or otherwise when the brake lining thickness 166 is greater than the burnished thickness. The additional brake pressure 174 can be desirable to compensate for a lack of friction that would otherwise result due to the lining 162 not being fully burnished, for example. In one configuration, the additional brake pressure 174 can be applied linearly 176 with respect to the cumulative wear of the lining 162. In another configuration, the additional brake pressure 174 can be applied based on a step function 178. In other words, a first brake pressure calibration 180 can be used until the cumulative wear reaches a first wear limit 182, a second brake pressure calibration 184 can be used until the cumulative wear reaches a second wear limit 186, and a third brake pressure calibration 188 can be used until the cumulative wear reaches a third wear limit 190. In general, the first brake pressure calibration adds more of the additional brake pressure 174 than the third brake pressure calibration 188. Once the cumulative wear is less than or equal to a burnished thickness (i.e., once the lining 162 is fully burnished), no additional pressure is added or required to achieve the intended brake torque 172. While the illustrative configuration includes three brake pressure calibrations 180, 184, 188, there could be n-number of brake pressure calibrations between the first, second, and third brake pressure calibrations 180, 184, 188 and/or n-number of brake pressure calibrations after the third brake pressure calibration 188 until the lining 162 is fully burnished. Note, selectively controlling the additional brake pressure 174 can be especially desirable for vehicles with regenerative braking systems. In other words, the additional brake pressure 174 can help accelerate the burnishing process even though the brakes pads 158 may not be relied on as often to decelerate the vehicle 100.

With reference to FIG. 4, a method 200 of burnishing one or more of the brake pads 158 is provided. The method 200 is initiated at 202. In practical terms, the method 200 is initiated during operation of the vehicle 100 (e.g., the ignition is in an on position)

At 204, the EBCM 136 can evaluate sensor data 123a, 123b from the sensor system 120 and determine whether one or more of the brake pads 158 is new. The brake pads 158 may be new if the vehicle 100 has low mileage or were recently replaced on the vehicle 100. In other words, the EBCM 136 can be configured to evaluate the mileage on the odometer of the vehicle 100 or evaluate a replacement status of the brake pads 158.

At 206, the EBCM 136 can evaluate the cumulative wear of the lining 162 based on the sensor data 123b gathered by the sensor system 120 and stored in the memory hardware 34, 134 and/or using one or more models, for example.

At 208, with reference to FIG. 4B, the first brake pressure calibration 180 can be selected by the EBCM 136 based on the cumulative wear. Additionally, the EBCM 136 can be configured to send instructions 137 to the vehicle brake system 140 to add the additional brake pressure 174 associated with the first brake pressure calibration 180.

At 210, the EBCM 136 continuously evaluates and/or estimates the cumulative wear of the lining 162 to determine when the first wear limit 182 is met. In other words, once the lining thickness 166 is less than or equal to the first wear limit 182 the method 200 proceeds to 212.

At 212, with reference to FIG. 4B, the second brake pressure calibration 184 can be selected by the EBCM 136 based on the cumulative wear. Additionally, the EBCM 136 can be configured to send instructions 137 to the vehicle brake system 140 to add the additional brake pressure 174 associated with the second brake pressure calibration 184.

At 214, the EBCM 136 continuously evaluates and/or estimates the cumulative wear of the lining 162 to determine when the second wear limit 186 is met. In other words, once the lining thickness 166 is less than or equal to the second wear limit 186 the method 200 proceeds to 216.

At 216, with reference to FIG. 4B, the third brake pressure calibration 188 can be selected by the EBCM 136 based on the cumulative wear. Additionally, the EBCM 136 can be configured to send instructions 137 to the vehicle brake system 140 to add the additional brake pressure 174 associated with the third brake pressure calibration 188.

At 218, the EBCM 136 continuously evaluates and/or estimates the cumulative wear of the lining 162 to determine when the third wear limit 190 is met. In the present illustrative configuration, once the lining thickness 166 is less than or equal to the third wear limit 186 the lining 162 is fully burnished.

At 220, a notification indicating that the brake pads 158 are fully burnished can be automatically populated by the vehicle control unit 138 and communicated to the user, operator, and/or owner of the vehicle 100. For instance, the notification can be communicated via an infotainment system of the vehicle 100 and/or via a mobile app on a mobile device in communication with the vehicle 100 via the network 40.

At 222, the method 200 ends.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method that, when executed by data processing hardware, causes the data processing hardware to perform operations comprising:
determining a status of one or more brake pads of a vehicle;
evaluating cumulative wear of the one or more brake pads;
selecting a brake pressure calibration based on the cumulative wear;
determining whether a wear limit has been met; and
generating a notification indicating the one or more brake pads are fully burnished.

2. The method of claim 1, wherein determining the status of one or more brake pads of a vehicle further includes determining whether the one or more brake pads are new based on mileage of the vehicle.

3. The method of claim 2, wherein determining the status of one or more brake pads of a vehicle further includes determining whether the one or more brake pads are new based on a replacement status.

4. The method of claim 1, wherein evaluating the cumulative wear of the one or more brake pads further includes collecting sensor data and using a model to estimate the cumulative wear.

5. The method of claim 1, wherein selecting the brake pressure calibration based on the cumulative wear further includes selecting a first brake pressure calibration.

6. The method of claim 5, wherein determining whether the wear limit has been met further includes determining whether a first wear limit has been met.

7. The method of claim 6, wherein selecting the brake pressure calibration based on the cumulative wear further includes selecting a second brake pressure calibration.

8. The method of claim 7, wherein determining whether the wear limit has been met further includes determining whether a second wear limit has been met.

9. The method of claim 8, wherein selecting the brake pressure calibration based on the cumulative wear further includes selecting a third brake pressure calibration.

10. The method of claim 9, wherein determining whether the wear limit has been met further includes determining whether a third wear limit has been met.

11. A system comprising:
data processing hardware; and
memory hardware in communication with the data processing hardware, the memory hardware storing instructions that, when executed on the data processing hardware, cause the data processing hardware to perform operations comprising:
determining a status of one or more brake pads of a vehicle;
evaluating cumulative wear of the one or more brake pads;
selecting a brake pressure calibration based on the cumulative wear;
determining whether a wear limit has been met; and
generating a notification indicating the one or more brake pads are fully burnished.

12. The system of claim 11, wherein determining the status of one or more brake pads of the vehicle further includes determining whether the one or more brake pads are new based on one of a mileage of the vehicle and a replacement status.

13. The system of claim 11, wherein evaluating the cumulative wear of the one or more brake pads further includes collecting sensor data and using a model to estimate the cumulative wear.

14. The system of claim 11, wherein selecting the brake pressure calibration based on the cumulative wear further includes gradually decreasing additional brake pressure as cumulative wear increases.

15. The system of claim 11, wherein determining whether the wear limit has been met further includes determining whether the cumulative wear is greater than or equal to a burnished thickness of the one or more brake pads.

16. A vehicle management system of a vehicle, comprising:
a vehicle brake system including one or more disc brakes having one or more brake pads;
a sensor system including a vehicle status subsystem and a vehicle brake system sensor subsystem;
data processing hardware; and
memory hardware in communication with the data processing hardware, the memory hardware storing instructions that, when executed on the data processing hardware, cause the data processing hardware to perform operations comprising:
determining a status of the one or more brake pads;
evaluating cumulative wear of the one or more brake pads;
selecting a brake pressure calibration based on the cumulative wear;
determining whether a wear limit has been met; and
generating a notification indicating the one or more brake pads are fully burnished.

17. The vehicle management system of claim 16, wherein determining the status of one or more brake pads of the vehicle further includes determining whether the one or more brake pads are new based on one of a mileage of the vehicle and a replacement status.

18. The vehicle management system of claim 16, wherein evaluating the cumulative wear of the one or more brake pads further includes collecting sensor data and using a model to estimate the cumulative wear.

19. The vehicle management system of claim 16, wherein selecting the brake pressure calibration based on the cumulative wear further includes gradually decreasing additional brake pressure as cumulative wear increases.

20. The vehicle management system of claim 16, wherein determining whether the wear limit has been met further includes determining whether the cumulative wear is greater than or equal to a burnished thickness of the one or more brake pads.
